(19) United States
(12) Patent Application Publication
(10) Pub. No.: US 2002/0066634 A1
(43) Pub. Date: Jun. 6, 2002

(54) Thrust plate assembly

(75) Inventors: Hartmut Bach, Schweinfurt (DE); Cora Carlson, Dittelbrunn (DE); Andreas Dau, Wurzburg (DE); Matthias Dorfler, Schweinfurt (DE); Gunther Esly, Wasserlosen (DE); Reinhard Feldhaus, Poppenhausen (DE); Ingrid Hoffelner, Knetzgau (DE); Christoph Kleuker, Gochsheim (DE); Paul Kraus, Niederwerrn (DE); Andreas Orlamunder, Schweinfurt (DE); Bernd Peinemann, Niederwerrn (DE); Michael Peterseim, Oberdorla (DE); Gerhard Roll, Eisenheim (DE); Ralf Till, Euerbach (DE); Sebastian Vogt, Bad Neustadt (DE); Thomas Schwingenstein, Stuttgart (DE)

Correspondence Address: COHEN, PONTANI, LIEBERMAN & PAVANE, Suite 1210, 551 Fifth Avenue, New York, NY, 10176, US

(73) Assignee: Mannesmann Sachs AG

(21) Appl. No.: 09/993,131

(22) Filed: Nov. 14, 2001

(30) Foreign Application Priority Data
Nov. 14, 2000 (DE) 100 56 277.9
Jun. 1, 2001 (DE) 101 26 782.7

(51) Int. Cl. F16D 13/71

(52) U.S. Cl. 192/70.18; 192/70.28

(57) ABSTRACT

A thrust plate assembly comprises a housing having a rotational axis, a pressure plate arrangement which is movable axially in the housing arrangement, and at least one coupling arrangement by which the pressure plate is coupled with the housing for transmission of torque, wherein a force component acting axially upon the pressure plate can be generated by the at least one coupling arrangement when the pressure plate is acted upon by rotational force in a first direction with respect to the housing arrangement. The at least one coupling arrangement is connected in a first coupling area thereof with a first coupling portion of the pressure plate and is connected in a second coupling area thereof with a second coupling portion of the housing, wherein the first coupling area and the second coupling area of the at least one coupling arrangement are axially offset relative to one another. A support arrangement supports the pressure plate relative to the housing when the pressure plate is acted upon by rotational force with respect to the housing arrangement in a second direction opposed to the first direction accompanied by at least partial relieving of the at least one coupling arrangement.

### BACKGROUND OF THE INVENTION

1. Field of the Invention

The present invention is directed to a thrust plate assembly comprising a housing arrangement, a pressure plate arrangement which is movable in the housing arrangement in direction of an axis of rotation, and at least one coupling arrangement by which the pressure plate arrangement is coupled with the housing arrangement for transmission of torque. A force component acting axially upon the pressure plate arrangement can be generated by the at least one coupling arrangement when the pressure plate arrangement is acted upon by rotational force in a first direction with respect to the housing arrangement. The at least one coupling arrangement is connected in a first coupling area thereof with a first coupling portion of the pressure plate arrangement and is connected in a second coupling area thereof with a second coupling portion of the housing arrangement. The first coupling area and the second coupling area of the at least one coupling arrangement are offset relative to one another in direction of the axis of rotation.

2. Description of the Related Art

Connecting a pressure plate to a housing arrangement by means of tangential leaf springs is a variant that has long been known in the area of friction clutches by which a pressure plate can be connected with the housing arrangement so as to be essentially fixed with respect to rotation and displaceable axially relative to this housing arrangement. In known friction clutches, the tangential leaf springs extend circumferentially from the respective connection areas of the pressure plate to an associated connection area of the housing arrangement. Since all tangential leaf springs are identically oriented in circumferential direction, a configuration results such that in pull operation, for example, the tangential leaf springs are also tensile loaded, while in push operation, that is, for example, when there is an engine braking effect, the tangential leaf springs are compression loaded. While this compression loading is not a problem in conventional arrangements in which these tangential leaf springs are constructed essentially flat, i.e., without curvature, problems result in arrangements which are constructed for generating a self-energizing or self-reinforcing pressing effect. In these thrust plate assemblies with self-reinforcing pressing effect, the tangential leaf springs are sharply curved in axial direction between the two areas of arrangement at the pressure plate on the one hand and the housing arrangement on the other hand. In pull operation, these tangential leaf springs which are then also tensile loaded tend to stretch, as a result of which, due to the axial offset of the two arrangement areas, the pressure plate is pressed with greater force against the friction linings of a clutch disk. However, in push operation, these sharply curved structural component parts can be very easily deformed and compressed which can even result in breakage of same.

### SUMMARY OF THE INVENTION

It is the object of the present invention to provide a thrust pate assembly with self-reinforcing pressing force effect in which relief from compressive loading is ensured for the at least one leaf spring arrangement.

According to the invention, the thrust plate assembly includes a support arrangement for supporting the pressure plate arrangement relative to the housing arrangement when the pressure plate arrangement is acted upon by rotational force with respect to the housing arrangement in a second direction opposed to the first direction accompanied by at least partial relieving of the at least one coupling arrangement.

According to the present invention, the coupling arrangement or every coupling arrangement is acted upon for the transmission of force essentially only in one direction of rotational force transmission, which is generally a direction in which this coupling arrangement is tensile loaded. The risk of excessive deformation compression can be avoided by providing the support arrangement acting in the other direction.

It may be provided, for example, that the support arrangement at the housing arrangement has at least one support area against which an associated counter-support area of the pressure plate arrangement can come into contact.

In this case, in order to provide elasticity when the support arrangement is operative and in order to prevent or dampen unwanted knocking noises, it is suggested that the support arrangement comprises at least one elastically deformable support element and that the counter-support area can come into contact at the support area with the intermediary of the at least one support element.

Further, it can be provided that the at least one support element has a through-opening for the at least one coupling arrangement, wherein it is preferably ensured that the at least one support element is held in the area of the through-opening at the at least one coupling arrangement.

In order to be able to contain torque peaks when the support arrangement becomes active, which generally occurs when a friction clutch containing a thrust plate assembly according to the invention is brought into a push state, for example, during engine braking action, it is suggested that an axial force component acting upon the pressure plate arrangement and directed opposite to the axial force component which can be generated by the at least one coupling arrangement can be generated by the cooperation of the at least one support area with the associated counter-support area. A contact pressing force can be generated in this way, as a result of which the clutch is permitted to slip.

For this purpose, the at least one support area and/or the at least one counter-support area can be provided with a support surface which is inclined in circumferential direction and with respect to a plane substantially orthogonal to the axis of rotation.

In order to be above to achieve the simplest possible construction in which the quantity of active parts is kept to a minimum, it is suggested that the at least one counter-support area is provided in the area of a first coupling portion of the pressure plate arrangement. On the other hand, for optimal adaptation of the various system areas to the requirements to be met by them, it can be provided that the at least one counter-support area is provided at a counter-support projection which is formed separately by a first coupling portion of the pressure plate arrangement.

In another constructional variant according to the invention, it can be provided that in at least one coupling arrangement the support arrangement comprises a support element which is supported in an area of the coupling arrangement between the first coupling area and the second coupling area. In order to achieve reliable circumferential support between the housing arrangement and the pressure plate arrangement, it is suggested that the support element comprises a fastening portion which is provided for securing to the at least one coupling arrangement, a first support arm which proceeds from the fastening portion and which can be supported with respect to the pressure plate arrangement, and a second support arm which proceeds in the opposite direction from the fastening portion in the first support arm and which can be supported with respect to the housing arrangement. It is preferably further provided that the first support arm and the second support arm can be supported essentially in circumferential direction at support areas provided at the pressure plate arrangement or housing arrangement. In order to prevent unwanted axial deflection of the support arms in the area of their support depending on friction conditions, it can be provided in addition that the first support arm and the second support arm can be supported at the pressure plate arrangement or housing arrangement in direction of the axis of rotation.

When a support element is provided, it can be provided for additional relief of a coupling arrangement that the first support arm and/or the second support arm has a support surface for the coupling arrangement carrying the at least one support element.

The at least one coupling arrangement can comprise at least one coupling element made of a one-piece material layer. In this respect, it may be provided, for instance, that the material layer comprises metal material, preferably spring steel, plastic material or the like.

In an alternative embodiment form, the at least one coupling arrangement comprises at least one coupling element of fiber material. It has turned out that forming a coupling element from fiber material leads on the one hand to an arrangement which is capable of transmitting very high torques but, on the other hand, due to the high flexibility of this coupling element, damage caused by deformation compression can be practically completely ruled out.

For this purpose, it can be provided, for example, that the fibers cooperate for transmission of force in the manner of a weave, knit, braid or the like. Alternatively or in addition, it is possible that the fibers of the fiber material are embedded in a matrix material at least in some areas to form a fiber composite.

With respect to the selection of fiber material when a coupling element is formed from fibers, it can be provided that the fibers comprise glass material, silicon carbide material, ceramic material, metal material, hemp, ramie or the like.

In another alternative embodiment form of a thrust plate assembly according to the invention, it can be provided that the at least one coupling arrangement has at least one coupling element with a plurality of coupling element members arranged successively in the longitudinal direction of the coupling element and connected with one another for force transmission. In this case, the at least one coupling element is accordingly constructed in the manner of a chain or a chain-like mesh.

The present invention is further directed to a friction clutch with a thrust plate assembly according to the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a partial longitudinal section through a friction clutch;

FIG. 2 is a schematic axial view of the pressure plate of the friction clutch shown in FIG. 1, which pressure plate is coupled with a housing arrangement;

FIG. 3 shows the principle of operation of a clutch with self-reinforcing action;

FIG. 4 is a sectional view from the radial outside showing the torque transmission coupling of the pressure plate and housing;

FIG. 5 shows a support arrangement acting between the housing and pressure plate;

FIG. 6 shows an alternative embodiment form of a support arrangement;

FIG. 7 shows another alternative embodiment form of a support arrangement;

FIG. 8 shows a top view of a coupling element which can be used in the thrust plate assembly according to the invention;

FIG. 9 shows another view of a support arrangement corresponding to FIG. 5;

FIG. 10 shows a top view of the support arrangement shown in FIG. 9;

FIG. 11 shows a sectional view of an elastic support element;

FIG. 12 shows an elastic support element which is arranged at the housing;

FIG. 13 shows a view of a thrust plate assembly according to the invention from the radial outside;

FIG. 14 shows a view of an alternative embodiment form corresponding to FIG. 13;

FIG. 15 shows another view of an alternative embodiment form corresponding to FIG. 13;

FIG. 16 shows another view of an alternative embodiment form corresponding to FIG. 13;

FIG. 17 shows another view of an alternative embodiment form corresponding to FIG. 13;

FIG. 18 shows another view of an alternative embodiment form corresponding to FIG. 13 with a support element supported at a coupling arrangement;

FIG. 19 shows another view of an alternative embodiment form corresponding to FIG. 13 with a support element supported at a coupling arrangement;

FIG. 20 shows a sectional view of the support element shown in FIG. 18 and the coupling arrangement in section along a line XX-XX in FIG. 18;

FIG. 21 shows a view corresponding to FIG. 20 of an alternative embodiment form;

FIG. 22 shows a view corresponding to FIG. 20 of an alternative embodiment form; and

FIG. 23 shows a top view of a coupling element enclosed by a support element.

### DETAILED DESCRIPTION OF THE PRESENTLY PREFERRED EMBODIMENTS

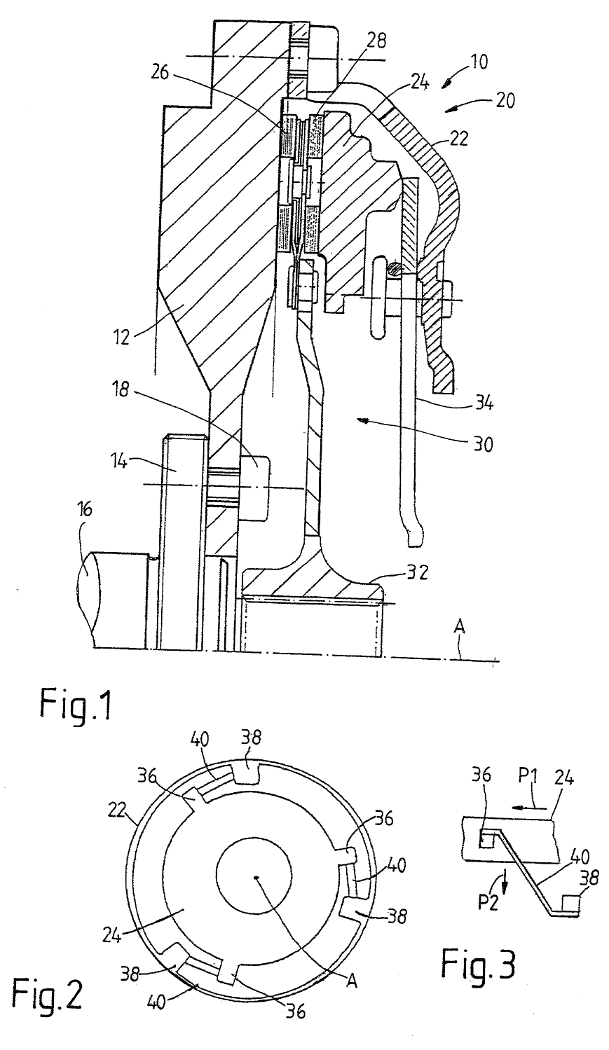

The basic construction of a friction clutch 10 in which the inventive principles are or can be realized is shown in FIGS. 1 and 2. The friction clutch 10 comprises a flywheel 12 which can be constructed, for example, as a dual-mass flywheel, which is secured in the radial inner area to a crankshaft flange 14 of a crankshaft 16 or some other drive shaft by a plurality of screw bolts 18. In its radial outer area, the flywheel 12 is fixedly connected with a thrust plate assembly 20. The thrust plate assembly 20 comprises a housing 22 and a pressure plate 24 which is axially displaceable in the housing 22 but is held so as to be substantially fixed with respect to rotation relative to the housing 22. The friction facings 26, 28 of a clutch disk 30 are located between the pressure plate 24 and the flywheel 12. This clutch disk 30 can be coupled in its radial inner hub area 32 with a driven shaft, for example, a transmission input shaft, so as to be fixed with respect to rotation relative to it. The pressure plate 24 is pretensioned basically in the direction of the flywheel 12 by an energy accumulator 34, for example, a diaphragm spring. In the present example, the clutch 10 is a push-type clutch.

As is shown in FIG. 2, coupling portions 36 and 38, respectively, as provided at the pressure plate 24 and at the housing arrangement 22 or, as the case may be, also at the flywheel 12. One of the coupling portions 36 and one of the coupling portions 38 are connected with one another by a coupling arrangement 40 extending approximately in circumferential direction. These coupling arrangements 40 are formed of flexible elements so that, in principle, an axial movement of the pressure plate 24 is possible for carrying out engagement and release processes. When the coupling portions 36, 38 are offset relative to one another in direction of the axis of rotation as is illustrated in FIG. 3 and the coupling arrangements 40 extend in the manner shown in FIG. 3, an application of force of the pressure plate 24 in circumferential direction with respect to the housing arrangement 22 in the direction indicated by the arrow P₁, which occurs, for example, in pull operation, results in a deflection of force due to lever ratios and leads to a reinforcement of the pressing force exerted on the friction facings 28, 26 by pressing force 24, which reinforcement is directed as indicated by arrow P₂. In this type of clutch 10 with a self-reinforcing effect, it is possible to achieve pressing forces which are fundamentally higher than those attainable by conventional diaphragm springs which still allow actuation. If an extremely high pressing force is not required, it is possible to provide the diaphragm spring and the energy accumulator 34 with lower pressing force capacity so that smaller release forces are also required.

It should be noted that only the basic construction of a friction clutch with self-reinforcing effect has been described thus far. Of course, a wide range of changes can be implemented in a clutch of this kind whether or not the principles of the present invention are applied, e.g., providing a wear compensating arrangement, a multi-mass flywheel as was already mentioned, a torsional vibration damper in the area of the clutch disk, and so on.

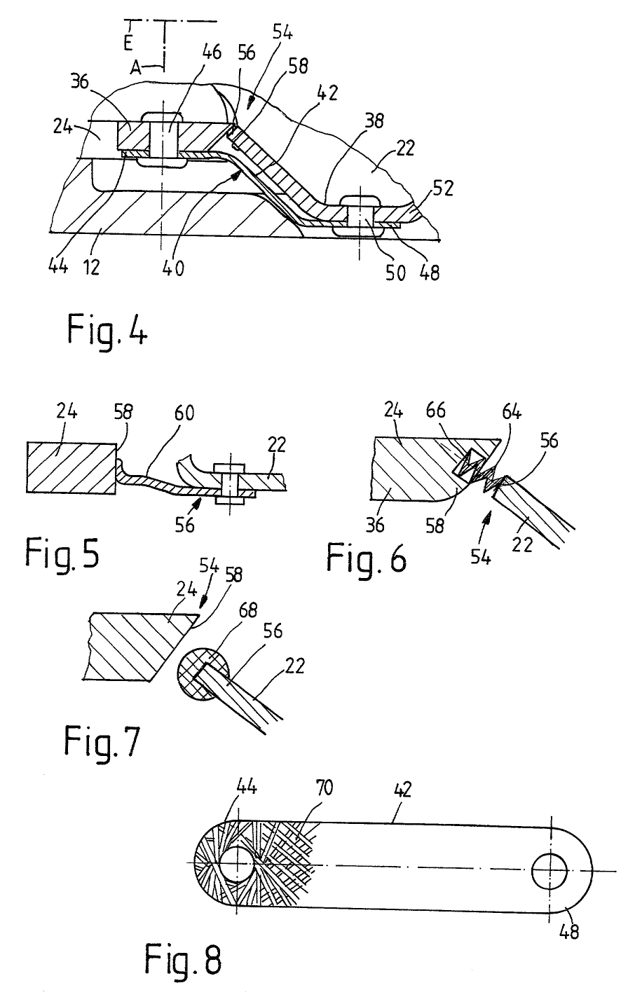

The torque transmission connection between the pressure plate 24 and the housing 22 in the area of the coupling arrangements 40 is shown in detail in FIG. 4. It will be seen that each coupling arrangement 40 comprises a coupling element 42, described more fully in the following, which extends approximately in circumferential direction and which is secured to the coupling portion 36 of the pressure plate 24 in a first coupling area 44 by means of a rivet stud 46 and, in a second coupling area 48 of the same, is secured by means of rivet studs 50 to a rim-shaped area 52 having the coupling portion 38 of the housing 22 and projecting radially outward. The two coupling areas 44, 48 are axially offset relative to one another in the installation position in order to receive the axial force component directed in the direction of arrow P₂, as is described with reference to FIG. 3, when the pressure plate 24 is acted upon in pull operation for rotational movement relative to the housing 22.

A support arrangement 54 is provided in order to prevent the above-mentioned effect of excessive deformation compression of the coupling element 42 also during transition to push operation. In the present example, this support arrangement 54 comprises, at the housing 22, a support area or a support surface 56 which is formed at the rim-shaped area 52 and on the opposite side of which is located a counter-support surface 58 which is formed at the coupling portion 36 of the pressure plate 24 and which provides a counter-support area. During the transition to push operation, that is, a state in which the pressure plate 24 is acted upon through the introduction of torque with respect to the housing 22 in such a way that the coupling portion 36 is displaced to the right with respect to the housing 22 in the view shown in FIG. 4, the two surfaces 56, 58 approach one another and, after a slight rotating movement of the pressure plate 24 with respect to the housing 22, come into contact with one another. In this state, the coupling arrangement 40 or every coupling arrangement 40 is relieved so that at least a majority of the torque transmitted between the housing 22 and the pressure plate 24 is transmitted via the support arrangement 54 and not any longer via the coupling arrangements 40. Since, further, the two surfaces 56, 58 which also proceed approximately from the radial inside to the radial outside extend in circumferential direction and at an inclination with respect to a plane E orthogonal to the axis of rotation A, a force is exerted when the surfaces 56, 58 contact the pressure plate 24 such that there is a force component opposed to direction P₂ by which the pressure plate 24 is acted upon in the direction away from the flywheel 12. Therefore, because of the reduced pressing force and the slipping movement of the clutch disk 30 with respect to the pressure plate 24 and flywheel 12 which accordingly becomes possible, torque peaks can be contained.

A further advantage of the inclined position of the two surfaces 56, 58 is that, for example, when the coupling element 42 or every coupling element 42, comprises a leaf spring element which is bent in the area between the two coupling areas 44, 48, the pressure plate 24 not only approaches the flywheel 12 when wear occurs, but also carries out a rotating movement because of the force deflection caused by these leaf spring elements. The distance between the two surfaces 56, 58 remains constant so that the support arrangement 54 ultimately has a constant support characteristic independent from wear.

In order to reduce collision of the two surfaces 56, 58 during spontaneous reversals in the direction of torque transmission, that is, during spontaneous transition from pull operation to push operation, and in particular also to prevent knocking noises, various elastic arrangements can be provided which act between the support area 56 at the housing 22 and the support area 58 at the pressure plate 24. FIG. 5 shows a leaf spring element 60 which is elastic in circumferential direction because of its curved contour. The leaf spring element 60 is secured to the housing 22 in a circumferential end area which, in the present example, is its end area near the housing 22. In the variant shown in FIG. 6, a support spring 64 is supported at the support area 56 of the housing 22 and is supported by its other end area at the pressure plate 24 or the coupling portion 36. In this case, a depression 66 is provided which prevents a lateral deflection and, further, provides a centrifugal force support for the spring 66.

In FIG. 7, a support element 68 of elastic material, for example, rubber or another elastic plastic material, is arranged at one of the support areas, namely, the support area 56 of the housing 22. The pressure plate 24 can contact this support element 68 with its counter-support area 58. A force deflection can be provided when an axially directed force component is generated, particularly also in the embodiment forms according to FIGS. 6 and 7 because of the effective force direction of the elastic elements 64, 68 on the one hand and also because of the surfaces (58 in the present example) which are oriented at an inclination on the other hand when the support arrangements 54 are active.

As was already stated, coupling elements 42 formed of leaf spring elements can be provided in the area of the coupling arrangements 40. Since the support arrangement 54 takes effect after only a brief compression deformation distance of these coupling elements 42, most of the supporting moment can be transmitted via the support arrangement 54 and each of the coupling elements is relieved. Further relief of the coupling elements 42 can be ensured when they are not constructed in such a way that they are also capable of transmitting circumferential force during compression deformation as is the case with leaf spring elements. For this purpose, it can be provided, for example, as is shown in FIG. 8, that the leaf spring elements 42 are formed of a plurality of individual fiber elements 70. These fiber elements 70 which are connected with one another in the manner of a weave, braid, knit or in some other way cooperate to transmit force under elongation stress but, due to their flexibility, can be compressed in the deformation compression direction essentially without the risk of damage or transmission of force via these fiber elements. Natural materials such as hemp and ramie can be materials for fibers of this kind, for example. Further, fibers of organic materials such as aramide fibers, fibers of carbon material, polyamide fibers, and so on, can be used. Inorganic fiber material such as glass fiber material, silicon carbide, ceramic material or metallic materials such as steel wire material. tungsten wire, aluminum and the like can also be used. In principle, it is also possible to embed the fibers in a matrix material at least in the end areas of the coupling elements in order to maintain a fiber composite material. In this case, metal materials such as steel and bronze, organic materials such as carbon material or duroplastic or inorganic materials such as ceramic materials, glass materials, silicon carbide and the like can be used as matrix materials.

In another alternative embodiment form, the coupling elements can comprise at least one layer of an isotropic, i.e., integral, material. This also ultimately includes the leaf spring elements mentioned above. However, in order to increase elasticity with respect to deformation compression, very thin layers can be used in this case so that the sheet thickness is only in the range of 1 to 100 μm. In order to obtain the required strength, a plurality of sheets of this type as well as sheets of different materials, if required, can be joined together with a coupling element 42. Metal materials, possibly also steel, polymer materials or other plastic materials, can also be used as materials for very thin, sheet-like layers of this type.

Due to the possibilities described above for constructing coupling elements in such a way that they are capable of transmitting very large forces under elongation but can be completely compressed under deformation compression and can finally not transmit any forces, the risk of damage during transition to the push state is further reduced. In coupling elements of this type, however, the support arrangement provided according to the principle of the present invention must be provided so that the required coupling can also be provided between the pressure plate and housing also when there is a reversal of the torque transmission direction.

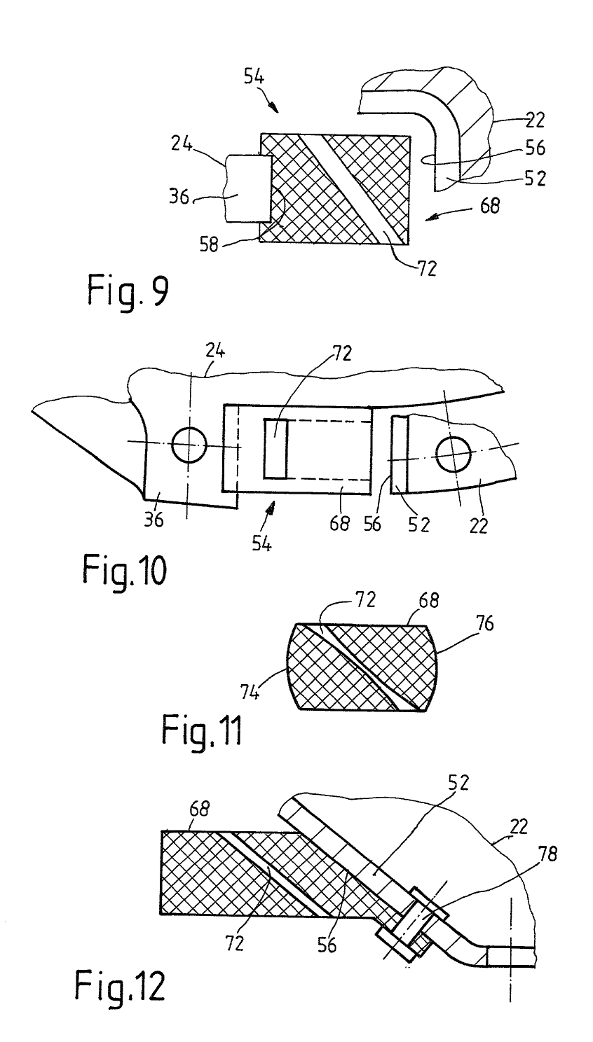

FIGS. 9 and 10 show an alternative type of construction of an elastic coupling element 68. This is constructed in a substantially block-like manner and in the present example is secured to a coupling portion 36 of the pressure plate 24, for example, by gluing, riveting or the like. A support surface 56 is further provided at the housing 22 and at the edge area 52 which projects radially outward, wherein the elastic support element 68 can come into contact with the edge area 52 in the push state. It will be seen that the elastic support element 68 has a through-opening 72 which extends at an inclination relative to plane E. This through-opening is provided for a coupling element 42 which, as shown for example in FIG. 4, extends at a corresponding inclination in the area between its two coupling areas 44, 48 between the housing 22 and the coupling portion 36 of the housing.

FIG. 11 shows an elastic support element 68 of the type mentioned above which is constructed to be secured at a coupling element 42 itself. For this purpose, the through-opening 72 is constructed in its longitudinal center area with a small opening cross section, so that clamping is achieved at the respective coupling element which can then have any desired material or configuration as was described above. In its two circumferential end areas, this elastic support element 68 has spherical support surfaces 74, 76 by which it can achieve contact at the respective support and counter-support areas 56, 58 of the housing 22 and pressure plate 24. The spherical construction of these surfaces 74, 76 has the advantage that a suitable pressing contact of the elastic support element 68 with respect to the housing 22 and pressure plate 24 is achieved even when there is a slight tilting of a coupling element under pushing stress caused by the occurring deformation compression. The elastic support element 68 shown in FIG. 12 is secured to the edge area 52 of the housing 22, for example, by a rivet stud 78, and is supported at a support surface 56 of the housing 22 in circumferential direction. In its other end area, the support element 68 can be supported at a respective portion of the pressure plate 24. In all of the embodiment forms described above as well as in the embodiment forms that will be described in the following, the support arrangement 54 has a plurality of elements or corresponding surface areas distributed along the circumference area which become active for supporting torque in push operation, preferably an area of this type with support surfaces and support elements allocated to every coupling arrangement 40.

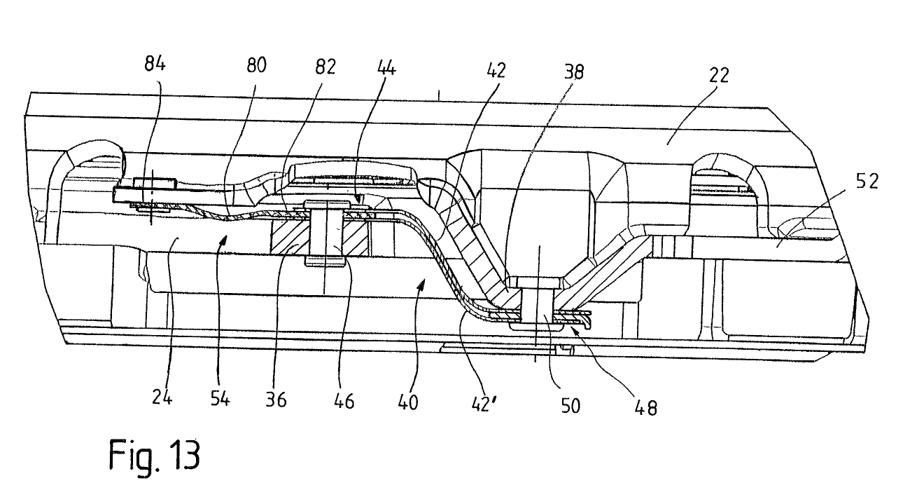

FIG. 13 shows an embodiment form in which the support arrangement 54 comprises a support element 80, e.g., a rope-like support element 80, which can be elongation loaded again but can essentially not be loaded by deformation compression. Accordingly, in this case, in principle, it is possible to use an element such as that which was described above with reference to its use in coupling elements and which has, for example, a plurality of fibers or filaments. This support element 80 can be fixedly connected in its two end areas 84, 82 with the housing 22, for example, in its edge area 52, and the pressure plate 24 by riveting. It will be seen further in FIG. 13 that the coupling arrangement 40 has two coupling elements 42, 42′ which are constructed in the manner of leaf springs and which extend alongside one another but which are virtually identical in principle. These coupling elements 42, 42′ are held at a distance from one another in their two coupling areas 44, 48 with the intermediary of spacer elements, wherein the flexible coupling element 80 also simultaneously forms the spacer element in the coupling area 44.

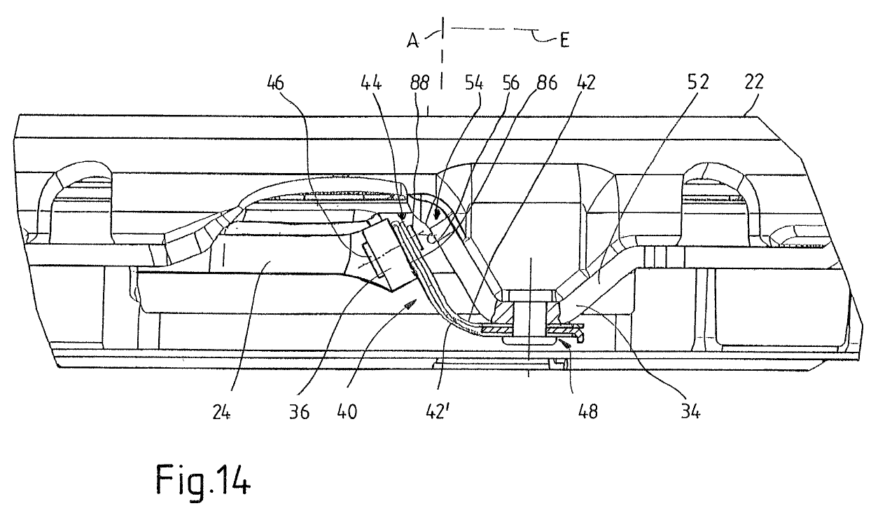

It will be seen in the embodiment form shown in FIG. 14 that the coupling portion 36 has a configuration which is rotated with respect to the embodiment forms shown in the preceding, i.e., essentially has a surface 86 for contacting the coupling arrangement 40, which surface 86 is inclined relative to plane E. This results in a configuration in which the coupling arrangement 40, which again, in the present example, is the two coupling elements 42, 42′ thereof, enclose an angle with their two coupling areas 44, 48, i.e., extend at an inclination relative to one another. The rim-like area 52 of the housing 22 is located opposite the first coupling area 44 and the rivet stud 46 by which the first coupling area 44 of the coupling elements 42, 42′ is arranged at the coupling portion 36 of the pressure plate 24, so that the rivet stud 46 can come into contact at the support area 56 provided at the housing 22 by its stud head 88. In this connection, the risk of excessive deformation compression or loading is ruled out, since the coupling elements 42, 42′, insofar as they are constructed as leaf spring elements, are bent further slightly only in the area in which they are already bent in any case.

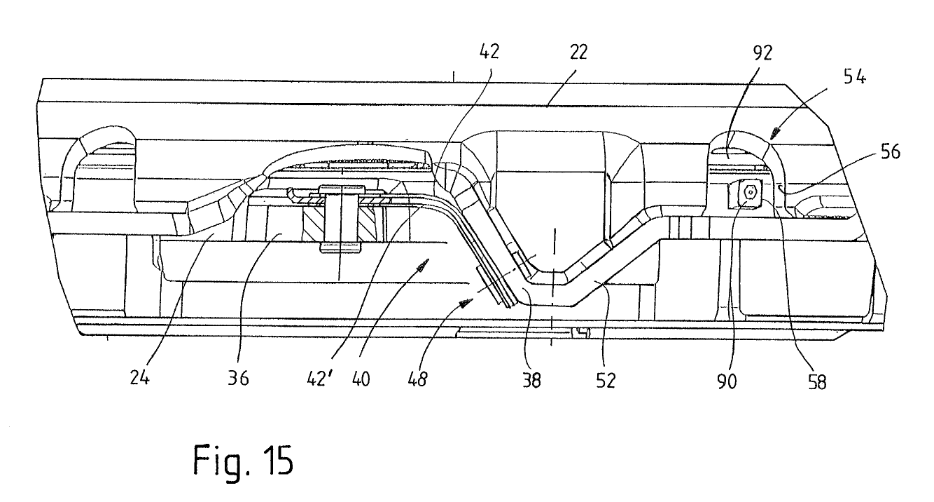

In the embodiment form shown in FIG. 15, the support arrangement 54 comprises at least one support projection 90 at the pressure plate 24, which support projection 90 is constructed separate from a respective coupling portion of the pressure plate 24. The support projection 90 projects radially outward into a recess 92 of the housing. A wall or surface defining the recess in circumferential direction forms the support area 56 across from which is located an oppositely oriented surface of the support projection 90 as counter-support area. In the area of the coupling arrangement or of every coupling arrangement in this embodiment form, the coupling elements 42, 42′ are arranged by their respective second coupling areas 48 at a coupling portion 38 of the housing 22 which is inclined with respect to the plane E mentioned above, so that, in this case, as in the embodiment form according to FIG. 14, there is only one bent area which is not excessively stressed under slight deformation compression loading.

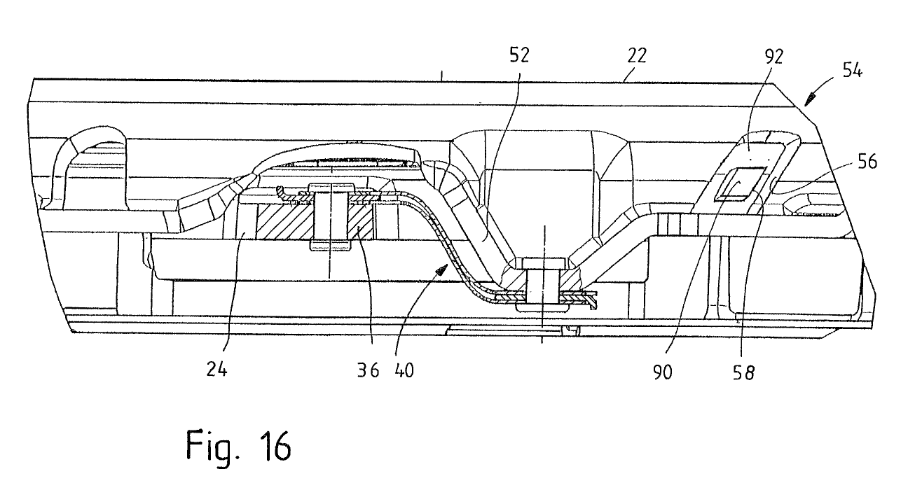

FIG. 16 shows a modification of the embodiment form shown in FIG. 15. It will be seen that the recess 92 of the housing 22 is constructed in such a way that a surface inclined relative to the plane E is provided in the support area 56. An inclined counter-support area 58 is provided at the support projection 90 in a corresponding manner. When this inclined counter-support area 58 comes into contact with the support area 56, the force deflection mentioned above with reference to FIG. 4 is generated again with the result that a force component is induced which acts upon the pressure plate 24 axially away from the flywheel. Of course, it is also possible in this connection, as in the embodiment form according to FIG. 15, to arrange an elastic material at a respective support projection 90 between the support area 56 or each support area 56 and the associated counter-support area 58 provided at the respective support projection 90 and accordingly to achieve a damping function.

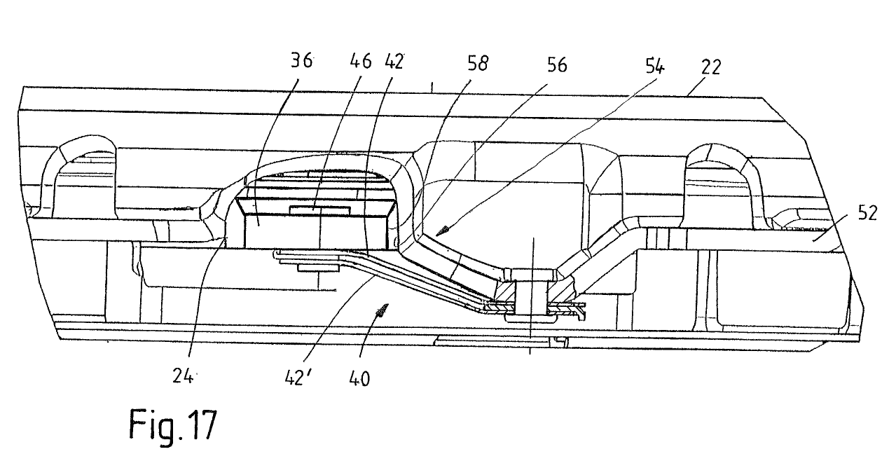

In the constructional variants shown in FIG. 17, it will be seen that the coupling elements 42, 42′ of the coupling arrangement 40 or each coupling arrangement 40 is secured in the area of the pressure plate 24 to the side of a respective coupling portion 36 facing the flywheel by means of a rivet stud 56. In this case, the support arrangement 54 comprises a support area 56 or support surface, preferably in the area of each coupling arrangement 40 at the radial outer edge area 52 of the housing, wherein across from this support area 56 or support surface in circumferential direction there is a corresponding counter-support area 58 or a corresponding surface of a respective coupling portion 36 of the pressure plate 24, which surface is directed in circumferential direction in a corresponding manner. An inclined orientation of these surface areas coming into supporting contact, as is shown in FIG. 16, would also be possible in this case in order to achieve the force component acting on the pressure plate 24 axially away from the flywheel during the transition to push operation.

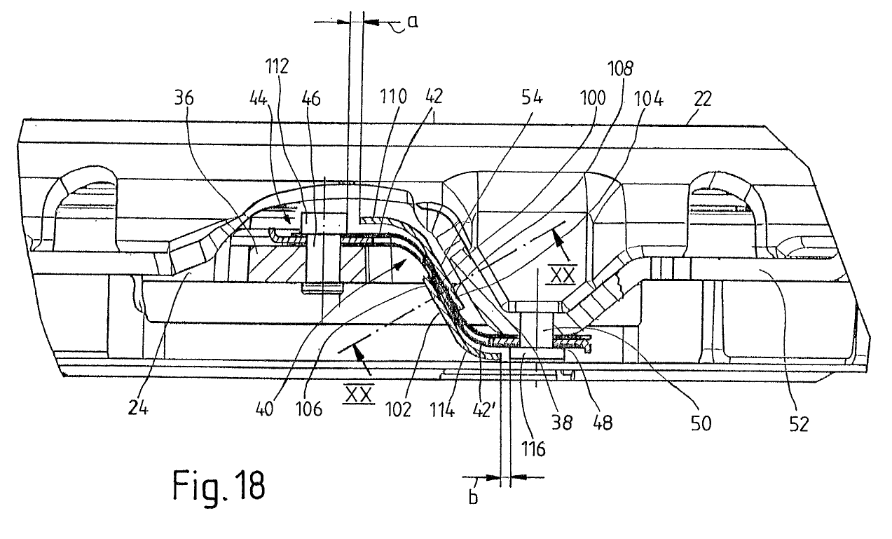

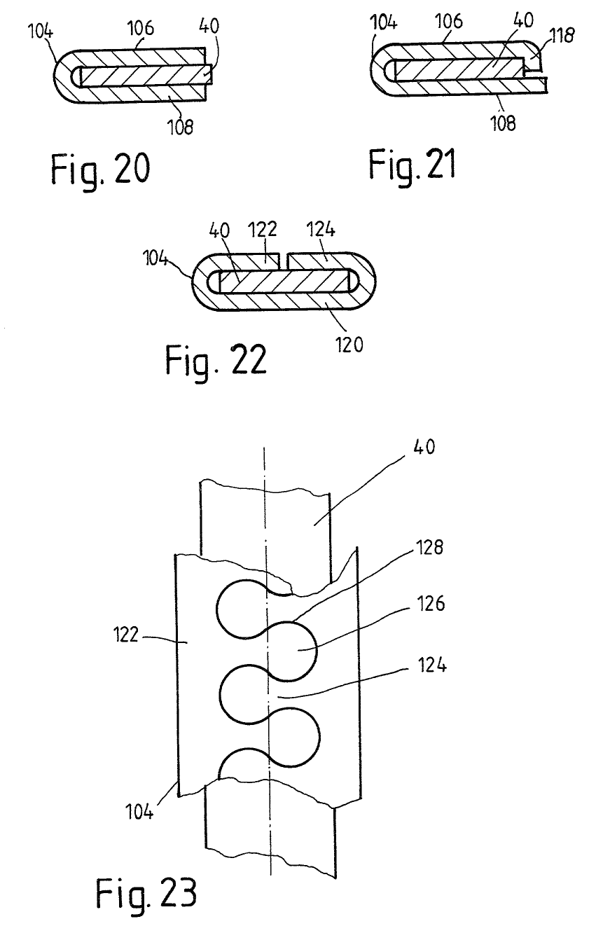

Another thrust plate assembly, according to the invention, with a support arrangement for relieving or by-passing the coupling arrangements 40 with respect to force is shown in FIG. 18. In the present example, the coupling arrangement or every coupling arrangement 40 again comprises two leaf spring elements 42, 42′ which are arranged at a distance from one another and which are bent next to both of their coupling areas 44, 48 to form a connection area 100 extending at an inclination. In this case also, of course, the coupling arrangements 40 can also be constructed in the manner described in detail above and can have other members used for coupling. The coupling arrangements 40 are surrounded by a support element 102 in their longitudinal central area, i.e., essentially in their connection area 100. In the present example, the support element 102 has an approximately U-shaped central body area 104 which, as can be seen in FIG. 20, contacts the two flat sides of the coupling arrangement 40 in its connection area 100 by its two U-legs 106, 108 and is held in this location, e.g., by clamping. A first support arm 110 with a shape matching the curvature of the coupling arrangement 40 between the connection area 100 and the coupling end area 44 is provided adjacent to the U-leg 108 and transverse to its U-extension direction, i.e., essentially along the coupling arrangement 40. In the unloaded state of the thrust plate assembly, i.e., in which it is not loaded by torque transmission, a circumferential end area of the support arm 100 is located opposite the head 112 of the rivet stud 46 with a circumferential distance “a” in the present example.

Proceeding in the opposite direction from the U-legs 106 to the first support arm 110 is a second support arm 114 which likewise has a shape adapted to the curvature of the coupling arrangement and whose circumferential end area is located opposite to the head 116 of the rivet stud 50 at a circumferential distance “b” which can correspond to distance a.

During torque transmission in the push state, the coupling portion 36 or every coupling portion 36 moves toward the associated coupling portion 38 of the housing 22 by rotation of the pressure plate 24 as is shown in FIG. 18. This movement is carried out as the above-mentioned circumferential distances “a” and “b” decrease until the support arms 110, 114 finally contact the stud heads 112, 116 and are supported at the latter in circumferential direction. A further movement in circumferential direction is then no longer possible, so that again the substantial proportion of torque is carried out via the support arrangement 54 and the support elements 102 thereof. The support elements 102 are prevented from tilting away in the clockwise direction with reference to FIG. 18 by the frictional contact with the stud heads 112, 116 on the one hand and by the inherent rigidity of the coupling arrangements 40 on the other hand when the latter are constructed, for example, as leaf spring elements. Further, it is possible to provide radial shoulders in the area of the stud heads 112, 116, which radial shoulders project radially outward with respect to the longitudinal axes of the studs. The respective support arms 110, 114 can also be supported in axial direction at these radial shoulders so as to be provide additional protection against tipping away. This is particularly advantageous when the coupling arrangements have no coupling elements forming independent pretensioning, for example when using the woven or braided coupling elements formed of a plurality of fibers.

Of course, when each coupling arrangement 40 has two coupling elements at a distance from one another as is shown in FIG. 18, intermediate elements should be provided not only in their coupling areas, but the two coupling elements should be held at a distance also in the connection areas enclosed by the support elements 102 by providing respective spacer elements. Another function of the support elements 102 and of the curved support arms 110, 114 thereof is that these support arms 110, 114 also contribute, in addition, in supporting the coupling elements in their curved areas in push operation due to the curvature areas of the support arms 110, 114 which are adapted to the curvature of the coupling arrangements 40,. Finally, very stiff areas serving for support can be used in the area of the support elements, while a rigidity of this kind is not possible in the area of the coupling elements due to the required elasticity.

FIG. 21 shows an arrangement in which a U-shaped clamping of the coupling arrangements 40 is provided in the central body area 104 of a support element 102 and in which a retaining shoulder 118 prevents lateral detachment. In the embodiment form shown in FIG. 22, the central body area 104 is constructed in such a way that it completely surrounds the associated coupling arrangement 40. One of the support arms can then be formed adjoining a continuous material portion 120, while the other support arm is formed by two material portions 122, 124 located at the opposite side of the coupling arrangement 40.

In the variant shown in FIG. 23 which shows a further development of the variant shown in FIG. 22, the two material portions 122, 124 which are produced by bending are provided in addition with projections and recesses which engage one inside the other, so that they are prevented from spreading apart by a positive engagement effect due to expanding projections 126 and correspondingly expanding recesses 128.

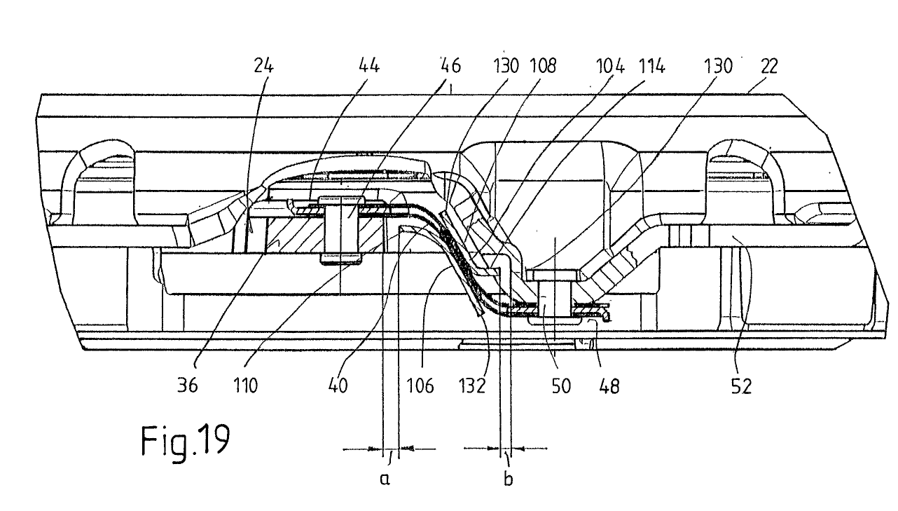

Another modification of the principle shown in FIG. 18 can be seen in FIG. 19. In this case, the support arm 110 cooperating with the pressure plate is provided at the U-legs and material portion 106 which are basically positioned facing the flywheel, so that it comes into direct contact with a coupling portion 36 for supporting torque. In a corresponding manner, the support arm 114 used for support with respect to the housing 22 is provided proceeding from the U-legs or material portion 108 positioned so as to face away from the flywheel, so that this support arm 114 can come into contact against a corresponding formed out area 130 of the housing 22 or edge area 52 thereof. This prevents an excessive loading of the rivet studs 46 and 50 by circumferential support. In addition, lengthening portions 132, 134 are provided adjoining the central body area 104 at the two U-legs or material portions 106, 108 at their end areas located opposite the respective support arms 110, 114 in longitudinal direction of the coupling arrangement 40. These lengthening portions 132, 134 extend up to the respective curvature areas of the coupling arrangement 40 and can provide for support at those places.

In the preceding, different steps have been shown by which the coupling arrangements and coupling elements serving for torque coupling between the pressure plate and the housing in pull operation can be relieved particularly during the transition to push operation. All of the steps or support arrangements described above preferably have a plurality of areas distributed along the circumference.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A thrust plate assembly comprising
a housing having an axis of rotation and a plurality of circumferentially arranged second coupling portions,
a pressure plate which is axially movable in the housing and has a plurality of circumferentially arranged coupling portions,
a plurality of coupling arrangements by which the pressure plate is coupled to the housing for transmission of torque, each said coupling arrangement having a first coupling area connected with a respective one of said coupling portions of said pressure plate and a second coupling area connected with a respective one of said coupling portions of said housing, said first coupling areas being axially offset from said second coupling areas, each said coupling arrangement generating a force component which acts axially on the pressure plate when the pressure plate is acted upon by a rotational force in a first direction with respect to the housing, and
a support arrangement for supporting the pressure plate axially relative to the housing when the pressure plate is acted on by rotational force in a second direction which is opposite to the first direction, accompanied by at least partial relieving of the coupling arrangements.

2. A thrust plate assembly as in claim 1 wherein said support arrangement has at least one support area and said pressure plate has at least one counter-support area which can come into contact with said support area.

3. A thrust plate assembly as in claim 2 wherein said support arrangement comprises an elastically deformable support element at each said at least one support area, and said counter-support area can come into contact with each said elastically deformable element.

4. A thrust plate assembly as in claim 3 wherein each said elastically deformable support element has an opening for receiving a respective coupling arrangement therethrough.

5. A thrust plate assembly as in claim 4 wherein each said elastically deformable support element is fixed to a respective coupling portion of the pressure plate.

6. A thrust plate assembly as in claim 2 wherein said at least one support area cooperates with said at least one counter-support area to generate an axial force component which is directed opposite to the axial force component which acts on the pressure plate.

7. A thrust plate assembly as in claim 6 wherein at least one of said support area and said counter support area comprises a support surface which is inclined in a circumferential direction with respect to a plane which is orthogonal to the axis of rotation.

8. A thrust plate assembly as in claim 2 wherein the at least one counter-support area is on the coupling portions of the pressure plate.

9. A thrust plate assembly as in claim 2 wherein said pressure plate comprises a first coupling portion having a counter-support projection, said at least one counter-support area being provided at said counter-support projection.

10. A thrust plate assembly as in claim 1 wherein said support arrangement comprises a support element which is supported by the coupling arrangement between the first coupling area and the second coupling area.

11. A thrust plate assembly as in claim 10 wherein said support element comprises a fastening portion for securing to the coupling arrangement, a first support arm extending from the fastening arrangement and supportable with respect to the pressure plate, and a second support arm extending from the fastening portion opposite from the first support arm and supportable with respect to the housing.

12. A thrust plate assembly as in claim 11 wherein the first and second support arms are supportable essentially circumferentially at the pressure plate and at the housing, respectively.

13. A thrust plate assembly as in claim 12 wherein the first and second support arms are supportable axially at the pressure plate and at the housing, respectively.

14. A thrust plate assembly as in claim 11 wherein at least one of the first and second support arms comprises a support surface for the coupling arrangement carrying the at least one support element.

15. A thrust plate assembly as in claim 1 wherein each said coupling arrangement comprises at least one coupling element made of a one-piece material layer.

16. A thrust plate assembly as in claim 15 comprises spring steel.

17. A thrust plate assembly as in claim 1 wherein each said coupling arrangement comprises at least one coupling element made of fiber material.

18. A thrust plate assembly as in claim 17 wherein said fiber material comprises fibers configured as one of a knit, a weave, and a braid.

19. A thrust plate assembly as in claim 17 wherein fiber material comprises fibers embedded in a matrix material to form a fiber composite.

20. A thrust plate assembly as in claim 17 wherein said fiber material comprises fibers consisting of at least one of glass, silicon carbide, ceramic, metal, hemp, and ramie.

21. A thrust plate assembly as in claim 1 wherein each said coupling arrangement has at least one coupling element with a plurality of coupling element members arranged successively and connected with each other for force transmission.

22. A friction clutch comprising a thrust plate assembly, said thrust plate assembly comprising
a housing having an axis of rotation and a plurality of circumferentially arranged second coupling portions,
a pressure plate which is axially movable in the housing and has a plurality of circumferentially arranged coupling portions,
a plurality of coupling arrangements by which the pressure plate is coupled to the housing for transmission of torque, each said coupling arrangement having a first coupling area connected with a respective one of said coupling portions of said pressure plate and a second coupling area connected with a respective one of said coupling portions of said housing, said first coupling areas being axially offset from said second coupling areas, each said coupling arrangement generating a force component which acts axially on the pressure plate when the pressure plate is acted upon by a rotational force in a first direction with respect to the housing, and
a support arrangement for supporting the pressure plate axially relative to the housing when the pressure plate is acted on by rotational force in a second direction which is opposite to the first direction, accompanied by at least partial relieving of the coupling arrangements.
